(19) United States
(12) Patent Application Publication
(10) Pub. No.: US 2004/0069419 A1
(43) Pub. Date: Apr. 15, 2004

(54) Door with door operator and method of fitting same

(76) Inventors: Axel Becker, Steinhagen (DE); Matthias Hedrich, Bielefeld (DE); Franz Ziesche, Halle Westfalen (DE)

Correspondence Address: STEVENS DAVIS MILLER & MOSHER, LLP, 1615 L STREET, NW, SUITE 850, WASHINGTON, DC, 20036, US

(21) Appl. No.: 10/668,190

(22) Filed: Sep. 24, 2003

(30) Foreign Application Priority Data
Sep. 25, 2002 (DE) 102 44 653.9

(51) Int. Cl. E05F 11/00

(52) U.S. Cl. 160/188

(57) ABSTRACT

Disclosed is a door (2) comprising a door leaf (1) and a door operator (10) for motorized operation of the door leaf (1) as well as an ID controlling and actuating means (12, 52) for mounting outside from the zone to be closed off, by means of which following or during implementation of an ID check an authorized user can enable the door operator (10) for the purpose of opening the door (2). Preferably to save, in an easy way time, material and money it is proposed in accordance with the invention to mount the ID controlling and actuating means (12, 52) on or in the door leaf (1) for movement therewith. In addition, the invention relates to a method of fabricating, furnishing and/or fitting such a door (2).

### FIELD OF THE INVENTION

The invention relates to a door comprising a door leaf and a door operator for motorized operation of the door leaf as well as including an ID controlling and actuating means to be fitted outside of the zone to be closed off. In addition, the invention relates to a method of fabricating, furnishing and/or fitting such a door.

### SUMMARY OF THE INVENTION

A preferred objective of the invention is to save, in an easy way, time, material and money where such doors or methods are concerned.

Preferably this objective is achieved by a door (2) comprising a door leaf (1) and a door operator (10) for motorized operation of the door leaf (1) as well as including an ID controlling and actuating means (12, 52) to be fitted outside of the zone to be closed off, by means of which an authorized user after being checked out for correct ID is able to actuate the door operator 10 for the purpose of opening the door (2), wherein the ID controlling and actuating means (12, 52) is mounted on or in the door leaf (1) for moving therewith.

Preferably, this objective is achieved by a method for fabricating, furnishing and/or fitting a door comprising the steps:

a) providing a door leaf (1) with an opening (40) suitable for mounting both a door lock (4) on the door leaf (1) and an ID controlling and actuating means (12, 52) on or in the door leaf (1), and providing a door frame (60) or members likewise to be secured fixed in place for securing and/or guiding the door

b) providing a mechanical bolting device (3) including a door lock (4) and corresponding manually operated bolting elements (3′) or a door operator assembly having a door operator (10) and an ID controlling and actuating means (12, 52) for enabling the door operator (10) for the purpose of opening the door (2) by means of an authorized user following or on implementation of an ID or authorization interrogation,

c) deciding whether the door (2) is to be operated manually or automatically,

d1) fitting the bolting device with the door lock (4 ) in the door leaf opening (40) and furnishing the door leaf (1) and the door members to be secured fixed—such as the door frame (60)—to the site, when the door (2) is to be operated manually, fitting the bolting device also being possible after furnishing to site,

or

d2) fitting the ID controlling and actuating means (12, 52) in the door leaf opening (40) and furnishing the door leaf (1), the door frame (60) or door members to be secured fixed and the door operator (10) to the site when the door (2) is to be operated automatically, fitting the ID controlling and actuating means (12, 52) also being possible after furnishing to site

and

e) fitting the furnished door parts on site.

Additional preferred advantageous aspects of the invention are also disclosed by the present specification.

### BRIEF DESCRIPTION OF THE DRAWINGS

The invention will now be detailed by way of an example embodiment with reference to the attached drawing in which:

FIG. 1 is an outer view of a door in accordance with one embodiment of the invention;

FIG. 2 is an inner view of a door leaf in accordance with prior art;

FIG. 3 is an outer view of the door leaf as shown in FIG. 2;

FIG. 4 is an inner view of a door leaf in a producing stage or producing step prior to the finished door in accordance with the invention as shown in FIG. 1;

FIG. 5 is an inner view in perspective of a first embodiment of the door in accordance with the invention; and

FIG. 6 is an inner view in perspective of a second embodiment of the door in accordance with the invention

### BACKGROUND OF THE INVENTION

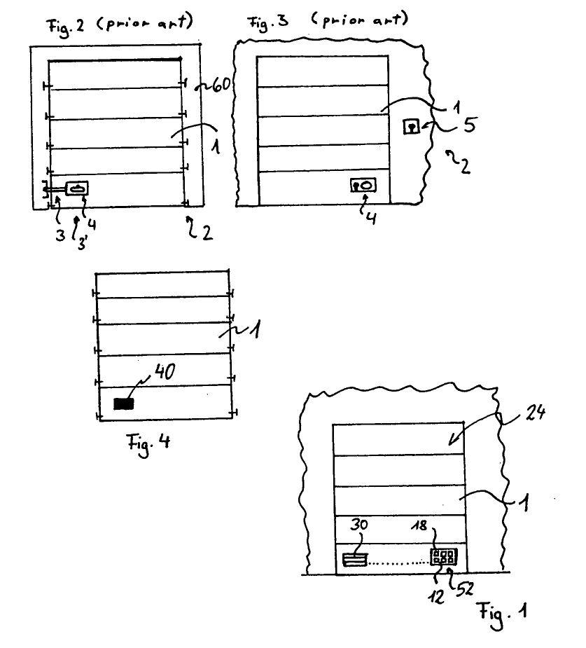

Referring now to FIGS. 2 and 3 there is illustrated a garage door leaf 1 of a usual door 2.

Most garage doors 2 are furnished or fitted nowadays with a door operator. When, however, a door is provided with a door operator, the mechanical bolting mechanisms 3 not required for powered operation need to be disabled, this involving more particularly the bolting mechanisms 3′ of the door lock 4.

This means that the majority of the bolting mechanisms 3′ required for exclusive manual operation of the door 2 are not needed at all, resulting in them having to be removed and disposed of—all a waste of time, material and money.

It thus makes much more sense to employ or fit these bolting mechanisms 3′ only when it is certain that the door is intended exclusively for manual operation.

Omitting the bolting mechanisms 3′ in conjunction with operation of the door by a door operator as described in the following is not intended to mean the mechanisms which are mandatory for emergency cases to open and close a door 2 from without and within, but merely the mechanisms as become superfluous by application of a door operator which as a rule is the door lock 4 with the mechanism connected thereto.

For doors including a door operator and the aforementioned bolting mechanisms 3′ accordingly omitted it thus needs to be assured by consequence that the door 2 can be opened externally without additional installations 5—this being the key switch usually required extra in the brickwork alongside the door—to at least equate it to operating the door exclusively by manual operation.

### DETAILED DESCRIPTION OF THE PREFERRED EMBODIMENTS

Referring now to FIGS. 1 and 5 there is illustrated the solution as preferred in this case substantially based on a door operator 10 usually being equipped with remote control permitting the door 2 to be opened and closed from without and within by radio (wireless) means, although, of course, a hardwired achievement—as shown in FIG. 6—is just as possible and practical.

### Solution 1—Preferred Embodiment as Shown in FIGS. 1 and 5

a) In the door leaf 1—preferably, of course, at the location where the door lock 4 with its associated mechanism 3 is fitted in exclusive manual operation of the door 2—a radio keypad controller 12, simply termed RKC 12 in the following, is fitted.

b) This RKC 12 comprises a transmitter 14 for wireless signalling a receiver 16 which in turn actuates the door operator 10.

c) On the outer side 24 of the door—FIG. 1—this RKC 12 includes a keypad 18 with which one or more key strike sequence(s) known specifically only to the user can be entered for emitting the transmission signal 20 for actuating the door operator 10. However, just as possible and practical are embodiments (not shown) in which the transmission signal 20 is activated by a mechanical or electronic key (e.g. transponder) or finger print sensors.

d) On the inner side 26 of the door—FIG. 5—i.e. in the zone to which non-authorized access is prevented—this RKC 12 has operation means (keys 28, switches or the like) permitting the user to “teach” the aforementioned key strikes or aforementioned electronic keys for enabling the aforementioned transmission signal in the RKC 12. It further being possible to also permit direct activation by these user operation means 28 of the aforementioned transmission signal 20 for actuating the door operator 10.

e) In accordance with further embodiments (not shown) it is also possible to wireless activate with this RKC 12 one or more extra functions by further receivers both directly and indirectly (following a key strike sequence or key) such as, for example, enabling patio lighting, a bell or an actuator in the vicinity.

f) This RKC 12 is energized battery or accumulator powered; although it is just as possible and practical to charge a rechargeable battery internal to the RKC 12 via solar cells 30 (either integrated in the RKC 12, or separately) on the outer side 24 of the door to permit operation in the dark.

g) It is likewise just as possible and practical to render the keypad 18 of the RKC 12 on the outer side 24 of the door illuminated, enabled e.g. by the first key strike in the dark and automatically disabled after a delay following the last key strike, to save energy.

This solution has the following advantages:

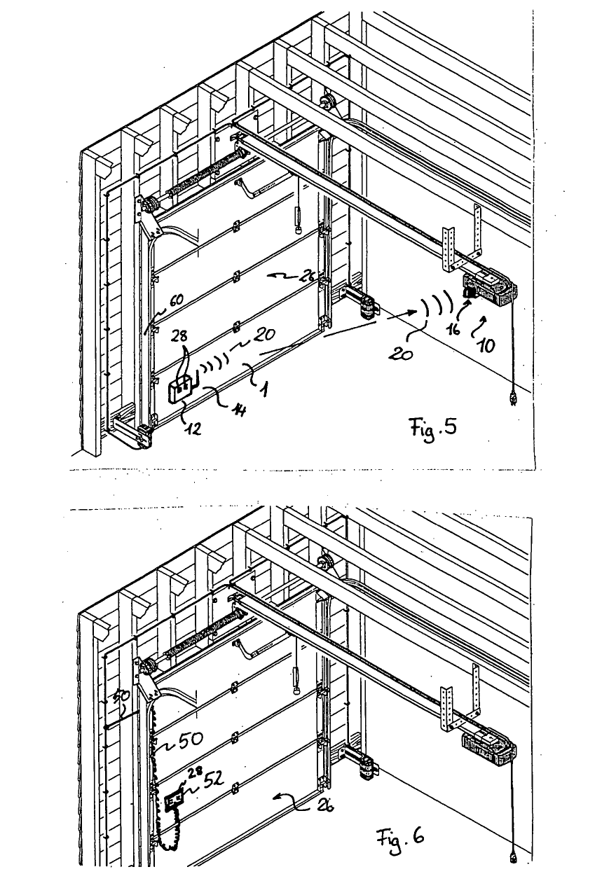

When it is known in fabrication of the door 2 that the door 2 is to be fitted with a door operator 10 including a receiver 16 the RKC 12 as described above is installed instead of the door lock 4 with the connected mechanism 3 or a trim plate—see FIG. 4 showing a door leaf blank with an opening 40 in the lock site. This opening 40 is closed off either by the door lock 4, by the RKC 12 or by a trim plate.

The wireless aspect of this embodiment eliminates the need to additionally wire the RKC 12 to the door operator 10.

Due to the achievement being integrated in the door leaf 1 and due to the wirelessness, no keypad 5 or inside keypads need to be installed for opening the door 2 from without or within, involving additional fitting and wiring complications. Closing the door (when the door is open the keypad of the RKC 12 on the outer side of the door is not accessible and the controls of the RKC 12 on the inside of the door not easily accessible) is preferably done by the handheld transmitter provided in any case or by an inner keypad connected to the door operator or to a separate housing of a door operator controller (not shown). As an alternative or in addition thereto, a timer switch may be provided for door closing.

### Solution 2—Alternative Embodiment (FIGS. 1 and 6)

In this aspect the components of the RKC 12 are eliminated permitting wireless activation of the door operator 10 therefrom. Instead, there is now provided a lead 50 from the controller, now termed keypad controller (KC) 52, in the door leaf 1 to the door operator 10 or a dedicated electronic analyzer in the zone to which unauthorized access is prevented for ultimately enabling the door operator. This achievement is characterized by:

a) In the door leaf 1 a wired keypad controller 52, simply termed KC 52 in the following, is fitted, preferably sited where the door lock 4 with the mechanism connected thereto is normally located for exclusive manual operation of the door 2.

b) This KC 52 is wired by a lead 50 to the door operator 10 or to a dedicated electronic analyzer (not shown) in the zone to which unauthorized access is prevented for ultimately enabling the door operator.

c) On the outer side 24 of the door—FIG. 1—this KC 52 includes a keypad 18 with which one or more key strike sequence(s) known specifically only to the user can be entered for emitting the signal 20 for actuating the door operator 10. However, just as possible and practical are embodiments (not shown) in which this signal 20 is activated by a mechanical or electronic key (e.g. transponder).

d) In the zone to which non-authorized access is prevented which may be on the KC 52 (on the inner side 26 of the door) itself, on the door operator 10 or on an electronic analyzer associated therewith—operation means (keys 28, switches or the like) are provided, enabling the user to “teach” the aforementioned key strikes or aforementioned electronic keys for enabling the aforementioned activating the door operator signal. It furthermore being possible to directly enable by these user operation means the aforementioned signal for actuating the door operator.

e) It is also possible with this KC 52 to enable one or more extra functions on the door operator 10 or electronic analyzer both directly and indirectly (following a key strike sequence or key) such as, for example, actuating patio lighting, a bell or actuator in the vicinity.

f) Due to this wired solution the KC 52 itself requires no power supply such as a battery or accumulator, since it can also be powered via the door operator 10 or analyzer.

g) It is likewise just as possible and practical to render the keypad of the KC 52 on the outer side 24 of the door illuminated, enabled e.g. by the first key strike in the dark and automatically disabled after a delay following the last key strike, to save energy.

This solution has the following advantages:

When it is known in fabrication of the door 2 that the door 2 is to be fitted with a door operator 10 (not necessarily involving a receiver) the KC 52 as described above including the prepared lead 50 is fitted instead of the door lock 4 with the connected mechanism 3 or a trim plate.

This wired solution eliminates batteries needing to be replaced or recharged.

Due to the solution being integrated in the door leaf 1 no keypads 5 or inside keypads need to be installed for opening the door 2 from without or within involving additional fitting and wiring complications. Closing the door (when the door is open the keypad of the KC 52 on the outer side of the door is non-accessible and the controls of the KC 52 on the inside of the door not easily accessible) is preferably done by the handheld transmitter provided in any case or by an inner keypad connected to the door operator or by a timer switch.

1. A door comprising a door leaf and a door operator for motorized operation of said door leaf as well as including an ID controlling and actuating means to be fitted outside of the zone to be closed off, by means of which an authorized user after being checked out for correct ID is able to actuate the door operator 10 for the purpose of opening said door, wherein said ID controlling and actuating means is mounted on or in said door leaf for moving therewith.

2. The door as set forth in claim 1, wherein the user enables said ID controlling and actuating means by entering a code or by a mechanical or electronic key.

3. The door as set forth in claim 1, wherein following entry of a code or touch or proximity contact of an ID object said ID controlling and actuating means emits a switching signal to a motor assembly of said door operator

4. The door as set forth in claim 1, wherein said ID controlling and actuating means on the outer side of said door leaf comprises a keypad, a finger print sensor switch or an ID card switch which emits a signal following or on proximity of an authorized ID card or other electronic key.

5. The door as set forth in claim 1, wherein said ID controlling and actuating means is provided with a transmitter, more particularly a radio transmitter, for emitting a switching signal to a receiver assigned to said motor assembly of said door operator.

6. The door as set forth in claim 5, wherein said door operator can be signaled by a remote handheld transmitter and said ID controlling and actuation means mounted on or in said door leaf is capable of emitting a signal corresponding to the signal of said handheld transmitter.

7. The door as set forth in claim 1, wherein said ID controlling and actuating means mounted on or in said door leaf for movement therewith is hardwired by a cable, more particularly by a spiral cable, to said motor assembly and/or a door operator control.

8. The door as set forth in claim 1, wherein said ID controlling and actuating means is provided on the inner side of said door leaf with smart user controls or operation means for teaching ID features for authorization and/or user controls or operation means for switching said door operator and/or ancillary functions.

9. The door as set forth in claim 1, wherein via said ID controlling and actuating means one or more additional electrical means, more particularly lighting, signaling or security systems can be enabled.

10. The door as set forth in claim 5, wherein said door operator can be signaled by a remote handheld transmitter in a vehicle and said ID controlling and actuation means mounted on or in said door leaf is capable of emitting a signal corresponding to the signal of said handheld transmitter.

11. The door as set forth in claim 1, wherein said ID controlling and actuating means is provided on the inner side of said door leaf with smart user controls or operation means for teaching ID codes or identifying electronic keys or finger prints, and/or user controls or operation means for switching said door operator and/or ancillary functions.

12. The door as set forth in claim 1, wherein said ID controlling and actuating means is provided on the inner side of said door leaf with smart user controls or operation means for teaching ID features for authorization and/or user controls or operation means for switching said door operator and/or ancillary functions selected from the group consisting of lighting, a bell or an actuator in the vicinity of the door.

13. A method for fabricating, furnishing and/or fitting a door comprising the steps:
a) providing a door leaf with an opening suitable for mounting both a door lock on said door leaf and an ID controlling and actuating means on or in said door leaf, and providing a door frame or members likewise to be secured fixed in place for securing and/or guiding said door,
b) providing a mechanical bolting device including a door lock (4) and corresponding manually operated bolting elements or a door operator assembly having a door operator and an ID controlling and actuating means for enabling said door operator for the purpose of opening said door by means of an authorized user following or on implementation of an ID or authorization interrogation,
c) deciding whether said door is to be operated manually or automatically,
d1) fitting said bolting device with said door lock in said door leaf opening and furnishing said door leaf and said door members to be secured fixed—such as said door frame to the site, when said door is to be operated manually, fitting said bolting device also being possible after furnishing to site,
or
d2) fitting said ID controlling and actuating means in said door leaf opening and furnishing said door leaf, said door frame or door members to be secured fixed and said door operator to the site when said door is to be operated automatically, fitting said ID controlling and actuating means also being possible after furnishing to site
and
e) fitting said furnished door parts on site.
